(19) United States
(12) Patent Application Publication
(10) Pub. No.: US 2009/0057110 A1
(43) Pub. Date: Mar. 5, 2009

(54) VIBRATION SWITCH

(75) Inventors: CHENG-HAO CHOU, Tu-Cheng (TW); TE-YUAN KUNG, Tu-Cheng (TW); WEN-HSIANG LU, Tu-Cheng (TW); KUAN-HONG HSIEH, Tu-Cheng (TW); JUI-LIN KE, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/199,806

(22) Filed: Aug. 28, 2008

(30) Foreign Application Priority Data
Aug. 31, 2007 (CN) 200710076762.X

(51) Int. Cl. H01H 35/14

(52) U.S. Cl. 200/61.51

(57) ABSTRACT

A vibration switch is provided. In an exemplary embodiment, the vibration switch includes an electrically insulating housing with a first contact terminal, and an electrically insulating cover with a second contact terminal. The vibration switch also includes a flexible cantilevered member and a metal sheet. The housing includes an opening that has a peripheral surface. The metal sheet is mounted on the peripheral surface and electrically connected with the first contact terminal. The flexible cantilevered member is attached to the cover and electrically connected with the second contact terminal and is received in the opening of the housing. When the vibration switch is shaken in a predetermined direction, the flexible cantilevered member deflects and contacts the metal sheet.

### BACKGROUND

1. Technical Field

The present invention relates to vibration switches and, more particularly, to a vibration switch changing between a switch-on state and a switch-off state when being shaken in a predetermined direction.

2. General Background

FIG. 5 shows a related-art vibration switch. The vibration switch includes two free moving metal balls. The two metal balls are electrically connected with a contact terminal respectively and lean against each other, thereby making the two contact terminals be in a normally closed state. When the vibration switch is jerked, the two metal balls can be shaken out of contact and the two contact terminals are turned to be in an electrically open state.

The vibration switch works well in some situations. However, because the two metal balls are freely moving without any restrictions, the vibration switch may change between the normally closed state and the electrical open state due to an unintentional change in position, or orientation, etc. In addition, some noise may be produced in the process of moving of the two metal balls.

Accordingly, there is a need to provide a vibration switch to solve the aforementioned problems.

### SUMMARY

A vibration switch is provided. In an exemplary embodiment, the vibration switch includes an electrically insulating housing with a first contact terminal, and an electrically insulating cover with a second contact terminal. The vibration switch also includes a flexible cantilevered member and a metal sheet. The housing includes an opening that has a peripheral surface. The metal sheet is mounted on the peripheral surface and electrically connected with the first contact terminal. The flexible cantilevered member is attached to the cover and electrically connected with the second contact terminal and is received in the opening of the housing. When the vibration switch is shaken in a predetermined direction, the flexible cantilevered member deflects and contacts the metal sheet.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a front view of a vibration switch in accordance with one embodiment of the invention.

FIG. 2 is a cross sectional view, taken along the line □-□, of the vibration switch of FIG. 1, showing a switch-on state and a switch-off state of the vibration switch.

FIG. 3 is a cross sectional view, taken along the line VII-VII, of the vibration switch of FIG. 1.

FIG. 4 is a cross sectional view of a vibration switch in accordance with another embodiment of the present invention.

FIG. 5 is a cross sectional view of a related-art vibration switch.

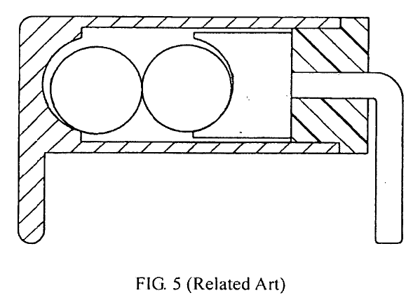

### DETAILED DESCRIPTION OF THE EMBODIMENTS

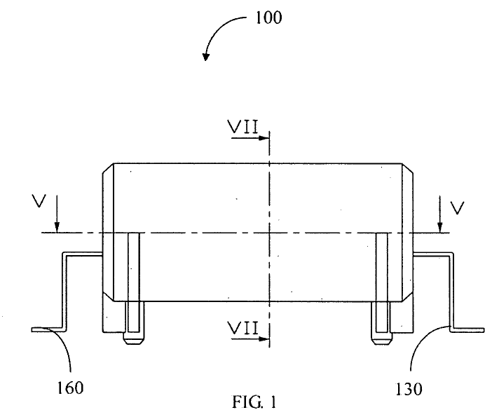

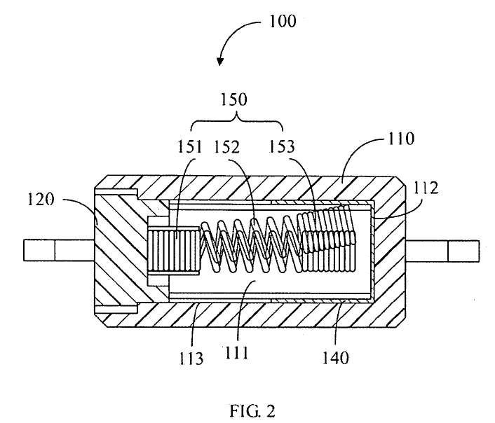

FIGS. 1, 2 and 3 show a vibration switch 100 in accordance with one embodiment of the present invention. The vibration switch 100 includes an electrically insulating housing 110 and an electrically insulating side cover 1 20. The vibration switch 100 also includes a first contact terminal 130, a metal sheet 140, a flexible member 150, and a second contact terminal 160.

The housing 110 may be made of plastic or other suitable electrically insulating materials. The housing 110 includes an opening 111 that extends longitudinally. The opening 111 includes a bottom surface 112 and a peripheral inner surface 113. In the illustrated embodiment, the peripheral surface 113 includes two planar portions 114 and 115 that are formed opposite to each other.

The first contact terminal 130 is attached to the housing 110 at one end. The metal sheet 140 is mounted on the bottom surface 112 and the planar portions 114 and 115. The first contact terminal 130 is electrically connected with the metal sheet 140. If the housing 110 is constructed of injection molded plastic, the first contact terminal 130 and the metal sheet can be integrated within the housing 110 by injection molding.

The cover 120 can be made of plastic or other suitable electrically insulating materials. The flexible member 150 and the second contact terminal 160 are attached to the cover 120 at two ends respectively. Specifically, the flexible member 150 is fixed in a cantilevered way. The flexible member 150 is electrically connected with the second contact terminal 160.

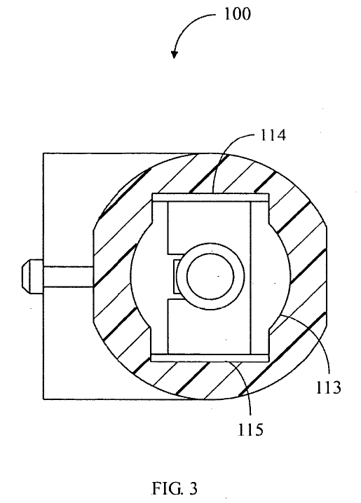

In the embodiment shown in FIG. 3, the flexible member 150 is an electrically conductive coil spring. The flexible member 150 includes a plurality of loops wound spirally about an axis. The flexible member 150 includes a fixed end 151, a middle deflectable portion 152, and a distal contact end 153. A first distance confined between two adjacent loops at the deflectable portion 152 along the axis is larger than a second distance confined between two adjacent loops at the distal contact end 153, thereby enhancing the sensitivity of the flexible member 150.

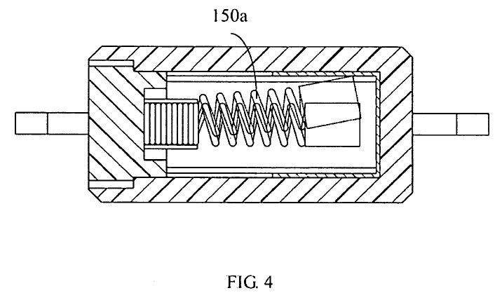

In another embodiment shown in the FIG. 4, the flexible member 150a is consisted of a spring and a metal member. The metal member is attached at one end to the spring and is used for enhancing the sensitivity of the flexible member 150a.

Referring back to FIG. 3, after the cover 120 is attached to the housing 110, the flexible member 150 is received in the opening 111 of the housing 110. The distal end 153 of the flexible member 150 is suspended in the opening 111 and does not contact the housing 110, thereby making the first contact terminal 130 and the second terminal 160 to be in a normally open state.

When the vibration switch is shaken in a predetermined direction, such as a direction approximately perpendicular to the planar portions 114 and 115, the flexible member 150 is deflected and when the distal end of the flexible member 150 contacts the metal sheet 140, the first contact terminal 130 and the second contact terminal 160 change from the normally open state to a closed state. After the shake ceases, the flexible member 150 returns to its original position and the vibration switch 100 returns to the normally open state.

However, if the vibration switch 100 is not shaken in the predetermined direction, the flexible member 150 deflects and contacts the peripheral surface 113 that is not covered by the metal sheet 140, the vibration switch 100 keeps in the normally open state.

In another embodiment according to the invention, the middle deflectable portion 152 is angled relative to the fixed end 151 and the distal contact end 153 contacts the metal sheet 140, thereby making the vibration switch 100 to be in a normally closed state. When being shaken, the vibration switch 100 may change between the normally closed state and an open state.

What is claimed is:

1. A vibration switch comprising:
an electrically insulating housing including an opening having a peripheral inner surface;
an electrically insulating cover attached to the housing;
a first contact terminal attached to the housing;
a second contact terminal attached to the cover;
a flexible cantilevered member with one end attached to the cover, electrically connected with the second contact terminal and received in the opening; and
a metal sheet mounted on the peripheral inner surface of the opening and electrically connected with the first contact terminal, wherein, the metal sheet is configured such that when the vibration switch is shaken in a predetermined direction, the flexible cantilevered member deflects and contacts the metal sheet.

2. The vibration switch according to claim 1, wherein the flexible cantilevered member is an electrically conductive coil spring.

3. The vibration switch according to claim 1, wherein the first contact terminal and the metal sheet are integrated within the housing.

4. The vibration switch according to claim 1, wherein the insulating housing is made of plastic.

5. The vibration switch according to claim 1, wherein the insulating cover is made of plastic.

6. A vibration switch comprising:
an electrically insulating housing including an opening having a peripheral inner surface;
an electrically insulating cover attached to the housing;
a first contact terminal attached to the housing;
a second contact terminal attached to the cover;
a metal sheet mounted on the peripheral surface of the opening and electrically connected with the first contact terminal; and
a flexible cantilevered member with one end attached to the cover, electrically connected with the second contact terminal, received in the opening and contacting the metal sheet, wherein, when the vibration switch is shaken in a predetermined direction, the flexible cantilevered member deflects and is out of contact with the metal sheet.

7. The vibration switch according to claim 6, wherein the flexible cantilevered member is an electrically conductive coil spring.

8. The vibration switch according to claim 6, wherein the first contact terminal and the metal sheet are integrated within the housing.

9. The vibration switch according to claim 6, wherein the insulating housing is made of plastic.

10. The vibration switch according to claim 6, wherein the insulating cover is made of plastic.
